(19) United States
(12) Patent Application Publication
(10) Pub. No.: US 2002/0168454 A1
(43) Pub. Date: Nov. 14, 2002

(54) Container

(75) Inventors: David Eugene Salmon, Hertfordshire (GB); Gerard Michael O'Brien, Hertfordshire (GB)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Manor Bakeries Limited, Buckinghamshire (GB)

(21) Appl. No.: 10/117,676

(22) Filed: Apr. 5, 2002

(30) Foreign Application Priority Data
Apr. 5, 2001 (GB) GB 0108625.5

(51) Int. Cl. A23B 4/00

(52) U.S. Cl. 426/124

(57) ABSTRACT

A container for storing one or more multi-packs in the form of a sleeve of material forming a base, two side walls, a lid and having an opening at either end, wherein said container is provided with means for securely retaining said one or more multi-packs within the sleeve. The container is typically used to store multi-packs containing items of food.

The present invention relates to a container for use with items of pre-packed food or drink.

A large number of foodstuffs are sold in the form of multi-packs. Typical examples include packages of cans or bottles, and tinned food. These packages are generally in the form of a material, such as plastic, wrapped around the individual items of food. The items are retained within the package by the wrapping itself being either tightly bound or folded in an appropriate way, or alternatively by using a separate securing means. An early example of a multi-pack is a pack of canned beverages held together by a plastic mesh.

Alternative packaging methods include tube-like structures to store small stackable items which are removed individually, for example snack products. Such packaging is often in the form of a re-sealable cannister.

The primary function of multi-pack packaging is to ensure that the “pack” remains intact during transportation and also to prevent the articles from being damaged prior to sale. Accordingly, this type of packaging is most frequently used externally.

In some instances foodstuffs are packaged in more than one layer. In these circumstances the packaging requires to be of a relatively complex design to ensure that the foodstuff is securely retained therein.

In the prior art there are a number of examples of multi-pack packaging. U.S. Pat. No 4,756,419 teaches the use of a container for a two-tiered multi-pack. U.S. Pat. No. 5,772,030 discloses a multi-pack packaging for two tiers which wraps round the enclosed items of food. These multi-packs are designed to be used as external packaging.

A recent development in the packaging of food is the use of small multi-packs contained within a larger package. The main advantage of the use of such smaller multi-packs is that the shelf life of the food is improved. For example, items of food are often sold in sealed packs for freshness with two or three individual items contained within each pack. Several of these packs are sold together so that the product is sold as a pack of, for example, two, four or six.

Individual items have also been packaged as part of a multi-pack, for example yoghurt is often sold in a pack of four or six pots. A problem with this type of packaging is that when one pot is removed several others can have their lid partially removed.

It would therefore be advantageous if there was a container which could hold several small multi-packs in such a way that the contents could be removed without affecting the remaining items of food.

An object of the present invention is provide a container for packaging one or more multi-packs, each multi-pack being provided with one or more items of food.

A further object of the present invention to provide a container whereby the individual items of food can be stored and isolated individually.

A further object of the present invention is to provide means whereby the items of food can be readily removed from the container.

A yet further object of the present invention is to provide a packaging arrangement which can easily be stacked in display, storage or during transport.

According to the present invention there is provided a container for storing one or more multi-packs in the form of a sleeve of material forming a base, two side walls, a lid and having an opening at either end, wherein said container is provided with means for securely retaining said one or more multi-packs within the sleeve. The sleeve will usually be formed from a strip of material joined at each end to form a loop.

Typically the sleeve is wrapped around the one or more multi-packs to be contained therein.

The sleeve is shaped to store the one or more multi-packs in one or more tiers. In a preferred embodiment the one or more multi-packs are stored in a plurality of tiers.

Preferably at least one of the side walls is provided with one or more projections which extend laterally from the sides of said wall to form or more channels which receive the one or more multi-packs.

More preferably at least one side wall is provided with at least two projections which extend out in opposite directions from the sides of the at least one side wall.

In a preferred embodiment at least one side wall is provided with a series of projections aligned vertically along both sides of said side wall.

Preferably the projections are themselves provided with tabs to retain a multi-pack within the container by engagement of the one or more tabs with the multi-pack.

Typically, the projections which retain the uppermost tier in the sleeve are not provided with tabs.

The sleeve is further provided with a handle for ease of use. Typically the handle is located in the lid of the sleeve. The handle is provided with an indentation which enables said handle to be frangibly upstood from the lid.

The sleeve may be made of any suitable material such as card or a plastic material.

An embodiment of the invention will now be described, by way of example only, with reference to the accompanying Figures in which:

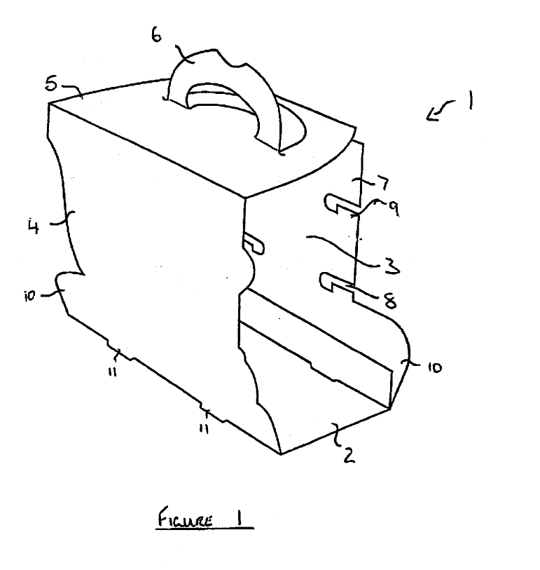

FIG. 1 illustrates a perspective view of a container in accordance with the present invention;

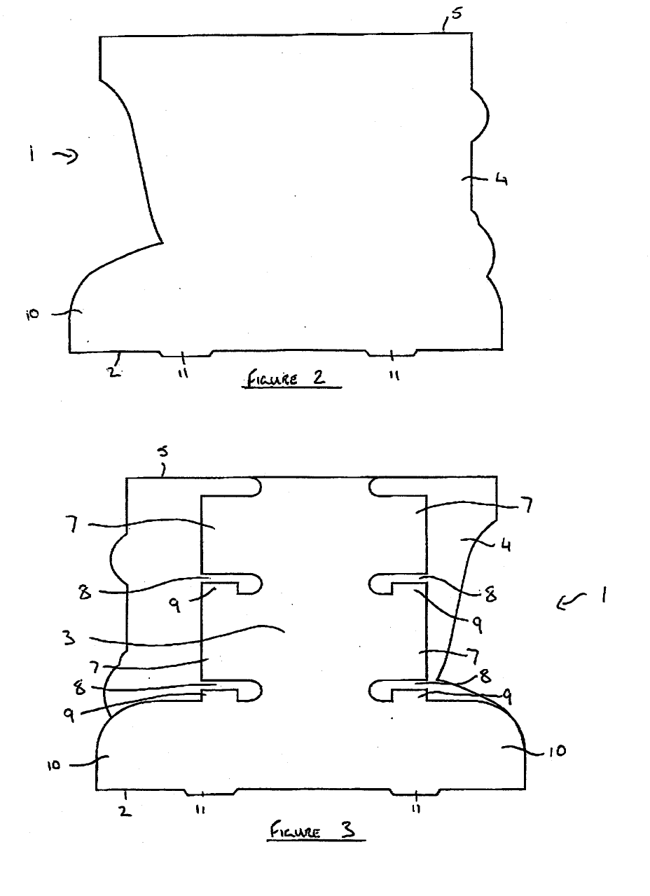

FIG. 2 illustrates a front-view of the container of FIG. 1;

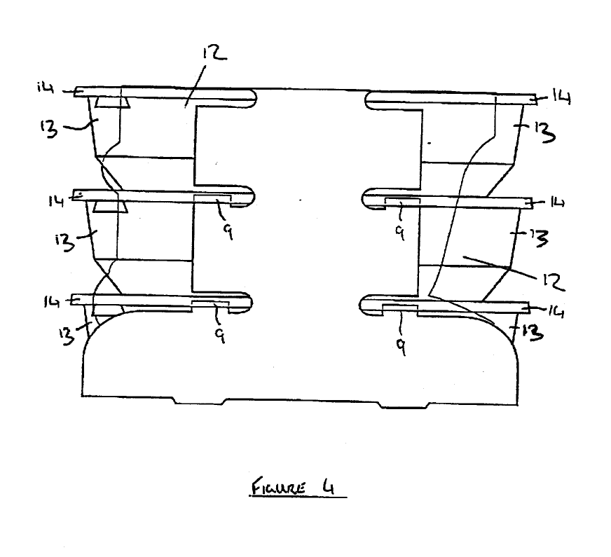

FIG. 3 illustrates a rear-view of the container of FIG. 1;

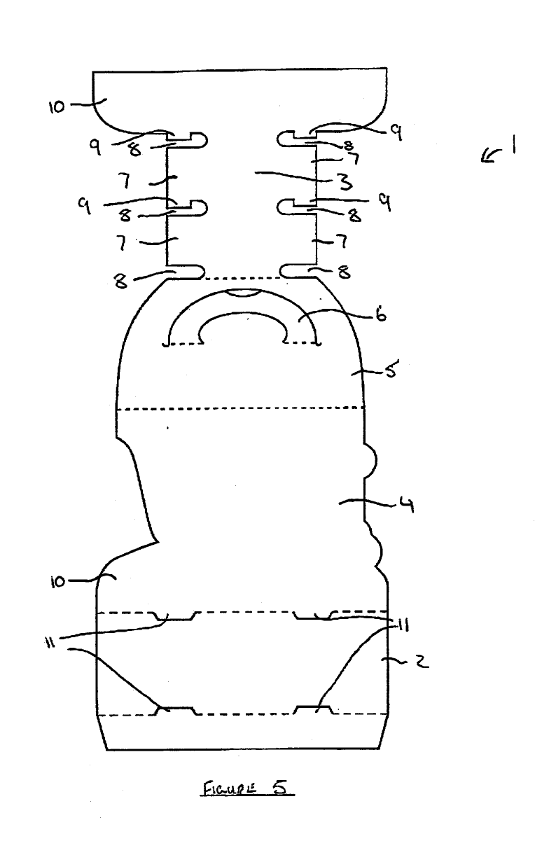

FIG. 4 illustrates the container of FIG. 1 with a number of items of food of pre-packaged food contained therein; and

FIG. 5 illustrates a plan view of a strip of material prior to assembly to form a container in accordance with the present invention.

Referring to FIGS. 1, 2 and 3 a container in the form of a sleeve is generally depicted at 1 comprising a base 2, a first side wall 3, a second side wall 4 and a lid 5. The lid 5 is provided with a handle 6. The handle 6 is provided with an indentation which enables the handle 6 to frangibly upstood from the lid 5. The first side wall 3 is provided with a series of projections 7. A series of gaps 8 are formed between the projections 7. The gaps 8 are able to receive a multi-pack (not shown). The projections 7 are provided with tabs 9. The tabs 9 act to retain the multi-packs (not shown) within the container 1.

The base 2 is provided with extended portions 10 which provide additional support to the items of food contained therein. In addition the base 2 is provided with feet 11 which are frangibly upstood from the base 2. The feet 11 provide support for the container 1 and prevent the base 2 from resting against a surface on which the container 1 is placed.

FIG. 4 illustrates the container of FIGS. 1, 2 and 3 provided with three multi-packs 12. The multi-packs 12 comprise two individual containers 13. The containers 13 are provided with a rim 14. Two of the multi-packs 12 are retained within the container 1 using the tabs 9 which are positioned under the rim 14 of each container 13. The uppermost multi-pack 12 is retained within the container 1 using the physical dimensions of the container 1.

The container 1 can be assembled in the following way. A series of multi-packs 12 are arranged in tiers. The sleeve is then wrapped around the tiers and secured to form the container 1. The tabs 9 are pushed under the rim 14 of each container 13.

In the example shown in FIG. 4 three layers each comprising two containers 13 are held in the container. Once a container 13 has been removed from a multi-pack 12 there exists the possibility that the remaining container 13 would be unable to be retained within the container 1. however, the presence of the tabs 9, which are located under the rim 14 of the multi-pack 12, prevents the remaining container 13 from being dislodged from the container 1.

FIG. 5 illustrates the strip of material which forms the container 1 prior to assembly.

An advantage of the present invention is that there is provided a container, in the form of a sleeve, for storing pre-packaged multi-packs of food wherein once an individual item of food is removed the remaining items can still be retained within the container.

A further advantage of the present invention is that such a container allows for the storage and retrieval of the individual items of food without affecting the packaging of the other items of food.

Further modifications and improvements may be incorporated without departing from the scope of the invention described herein.

1. A container for storing one or more multi-packs in the form of a sleeve of material forming a base, two side walls, a lid and having an opening at either end, wherein said container is provided with means for securely retaining said one or more multi-packs within the sleeve.

2. A container as claimed in claim 1 wherein the sleeve is formed from a strip of material joined at each end to form a loop.

3. A container as claimed in claim 1 wherein the sleeve is wrapped around the one or more multi-packs to be contained therein.

4. A container as claimed in claim 1 wherein the sleeve is shaped to store the one or more multi-packs in one or more tiers.

5. A container as claimed in claim 4 wherein the one or more multi-packs are stored in a plurality of tiers.

6. A container as claimed in claim 1 wherein the retaining means is in the form of one or more projections which extend laterally from at least one side wall and which are aligned vertically to form or more channels which receive the one or more multi-packs.

7. A container as claimed in claim 6 wherein the at least one side wall is provided with at least two projections to act as the retaining means which extend laterally in opposite directions from the sides of the at least one side wall.

8. A container as claimed in claim 6 wherein the projections are themselves provided with tabs to retain a multi-pack within the container by engagement of the one or more tabs with the multi-pack.

9. A container as claimed in claim 8 wherein the projections which retain the uppermost tier in the sleeve are not provided with tabs.

10. A container as claimed in claim 1 wherein the sleeve is further provided with a handle for ease of use.

11. A container as claimed in claim 10 wherein the handle is located in the lid of the sleeve.

12. A container as claimed in claim 11 wherein the handle is provided with an indentation which enables said handle to be frangibly upstood from the lid.

13. A container as claimed in claim 1 wherein the sleeve may be made of any suitable material such as card or a plastic material.

14. A container for storing one or more multi-packs in the form of a sleeve of material forming a base, two side walls, a lid and having an opening at either end, wherein said container is provided with retaining means for securely retaining said one or more multi-packs within the sleeve wherein the retaining means is in the form of one or more projections which extend laterally from at least one side wall and which are aligned vertically to form or more channels which receive the one or more multi-packs.

15. A container for storing one or more multi-packs in the form of a sleeve of material forming a base, two side walls, a lid and having an opening at either end, wherein said container is provided with retaining means for securely retaining said one or more multi-packs within the sleeve wherein the retaining means is in the form of at least two projections which extend laterally in opposite directions from at least one side wall and which are aligned vertically to form or more channels which receive the one or more multi-packs
